(19) United States
(12) Patent Application Publication
(10) Pub. No.: US 2004/0172538 A1
(43) Pub. Date: Sep. 2, 2004

(54) Information processing with data storage

(75) Inventors: Akashi Satoh, Yamato-shi (JP); Sumio Morioka, Yamato-shi (JP); Kohji Takano, Yamato-shi (JP)

Correspondence Address: Louis P. Herzberg, Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/730,773

(22) Filed: Dec. 9, 2003

(30) Foreign Application Priority Data
Dec. 18, 2002 (JP) 2002-367334

(51) Int. Cl. H04L 9/00

(52) U.S. Cl. 713/175

(57) ABSTRACT

A data storage device includes an encryption circuit for encrypting desired data and personal identification information by use of an encryption key created out of a given piece of the personal identification information such as a password, a magnetic disk for recording the data and the personal identification information which are encrypted by the encryption circuit, and a central processing unit for executing user verification by use of the encrypted personal identification information stored in the magnetic disk. The user verification is executed based on such verification data. The write data transmitted from a host system are encrypted by use of the foregoing encryption key and are recorded in the magnetic disk. Alternatively, the data read out of the magnetic disk are decrypted by use of the encryption key and are transmitted to the host system.

### FIELD OF INVENTION

The present invention relates to data encryption processing (encryption of write data and decryption of read data) in an external storage device (a data storage device) represented by a hard disk device.

### BACKGROUND OF THE INVENTION

There are various external storage devices for a computer system such as magnetic disk devices (a hard disk drive and the like), optical disk devices, or memory cards using semiconductor memories. Various measures have been introduced to protect the data to be stored in these storage devices from the viewpoint of security. Among them, a password lock function is normally supported as a user verification function in a hard disk device in which a user frequently stores personal information. In the password lock function, a password set by the user is written in a special area of the hard disk, whereby the hard disk is operated to accept an access request if a password inputted upon starting up matches the previously written password, or refuses the access to the hard disk device if the passwords do not match each other.

Meanwhile, encryption of the data stored in the storage device (hereinafter referred to as the “stored data”) is effective as means for protecting the stored data from an access by a third party. Conventionally, in the case of encrypting the data to be stored in the storage device, such data has been encrypted before storing it in the storage device by use of encryption software or hardware provided in a computer device side (see Patent References 1 and 2, for example).

(Patent Reference 1)

Japanese Unexamined Patent Publication No. 2002-319230

(Patent Reference 2)

Japanese Unexamined Patent Publication No. 11 (1999)-352881

By use of the user verification such as the password lock and the encryption of the stored data at the same time as described above, it is possible to eliminate the risk of a theft of the contents of the stored data by a third party even if the user verification is unlocked by the third party. However, there is a problem happening as to how to provide a key to the encryption (hereinafter referred to as the “encryption key”).

The length of the encryption key is usually 128 bits or longer, which is too long for the user to provide directly upon the encryption or the decryption of the stored data. On the contrary, the function of encryption will be lost if the encryption key is recorded and held in a recording medium. Accordingly, when the user verification and the encryption of the user data are used at the same time, one conceivable mode is to create the encryption key based on personal identification information (including the password) to be used for the verification. However, in this mode, the encryption key is changed every time when the personal identification information is changed periodically or at random from the viewpoint of security. Accordingly, it is necessary to decrypt the data with the old encryption key, and to encrypt the stored data again with the new encryption key. Storage capacities of hard disk devices have been increasing in these days, and some of them may exceed 100 gigabytes (GB). As a consequence, it will take a lot of time if re-encryption of the stored data is requested every time of changing the personal identification information, which is not deemed preferable.

Meanwhile, it is becoming more popular in these days to implement the hard disk device detachably (removably) on the computer device, so that the data are utilized by changing the hard disk device or by setting the hard disk device to another computer device. When a data encryption function is implemented on the hard disk under such use circumstances, it is necessary to thoroughly consider on compatibility with a hard disk which does not include the encryption function. Here, preparation of a special command for initial setting upon execution of encryption is not a problem. However, in the implementation where a special command is also required for read/write processing upon data encryption, significant modification of a basic input/output system (BIOS) or an operating system (OS) is necessary for supporting such a command, which is not deemed preferable.

It is also possible to determine as to whether or not encryption of the stored data in the hard disk device is executed with the entire magnetic disk by means of setting jumper pins or by format options. However, many hard disk devices are built-in in computer devices recently and are shipped after pre-installation of the OS and other software. Accordingly, it is not possible to encrypt the data at this initial state. It is because a secret key for encryption should be determined by each user and should be different in each disk.

In this case, there is also an option which is to turn off the encryption function upon the above-mentioned pre-installation of the software so as to allow the user who needs the encryption function to conduct encryption of the entire magnetic disk by himself. However, if the storage capacity of the magnetic disk is large, it takes a lot of time for the encryption processing of the entire magnetic disk. As a consequence, the burden on the user is increased.

Moreover, it is also possible to divide the storage area of the magnetic disk into an encrypted area and a non-encrypted area, and to write the preinstalled data in the non-encrypted area. However, modification of the system such as the OS becomes necessary for constantly monitoring to avoid the data from being transferred between the encrypted area and the non-encrypted area upon subsequent data reading or writing.

### SUMMARY OF THE INVENTION

Accordingly, an aspect of the present invention is to achieve encryption processing of the stored data and management of an encryption key, which are suitable for the case when user verification and encryption of the stored data are applied to a storage device at the same time.

Another aspect of the present invention is to provide a method of encryption processing for the stored data suitable for a detachably implemented storage device, and to provide a storage device which can achieve the method of encryption processing.

To attain the foregoing aspects, the present invention is realized as a data storage device to be configured as follows. Specifically, the data storage device includes an encryption circuit for encrypting desired data and personal identification information by use of an encryption key created out of a given piece of the personal identification information such as a password; a recording medium for recording the data and the personal identification information which are encrypted by the encryption circuit, and a control unit for executing user verification by use of the encrypted personal identification information stored in the recording medium.

Still another aspect of the present invention for attaining the foregoing aspects is also realized as a data storage device configured as follows. Specifically, the data storage device includes a magnetic disk, a read-and-write mechanism for reading and writing data, and a control mechanism which has an encryption function for encrypting data to be written in the magnetic disk and for decrypting the encrypted data to be read out of the magnetic disk, and controls reading and writing of the data by the reading-and-writing mechanism.

Moreover, another data processing method according to the present invention includes the steps of creating an verification encryption key out of a given piece of personal identification information, encrypting the personal identification information by use of the verification encryption key and thereby recording the encrypted personal identification information in a recording medium as verification data while encrypting a data encryption key by use of the verification encryption key and thereby recording the encrypted data encryption key in the recording medium, executing user verification based on the verification data, decrypting the data encryption key by use of the verification encryption key, and encrypting write data transmitted from a host system by use of the decrypted data encryption key and thereby recording the encrypted write data in the recording medium or decrypting the data read out of the recording medium by use of the data encryption key and thereby transmitting the decrypted data to the host system.

### BRIEF DESCRIPTION OF THE DRAWINGS

For a more complete understanding of the present invention and the advantages thereof, reference is now made to the following description taken in conjunction with the accompanying drawings.

FIG. 1 is a view showing a configuration example of a hard disk device according to an embodiment of the present invention.

FIG. 2 is a view describing a method of initial setting of user verification according to the embodiment.

FIG. 3 is a view describing a method of the user verification and encryption processing of stored data according to the embodiment.

FIG. 4 is a view describing a method of restoring the stored data when a trouble occurs in a magnetic disk according to the embodiment.

FIG. 5 is a view describing a method of restoring the stored data by use of a master key according to the embodiment.

FIG. 6 is a view describing a method of setting verification data for canceling a lock of the hard disk device in addition to other verification data based on personal identification information.

FIG. 7 is a view describing a responding method for the encryption processing in a case of changing the personal identification information according to the embodiment, which describes an operation of initial setting.

FIG. 8 is another view describing the method for the encryption processing in the case of changing the personal identification information according to the embodiment, which describes the user verification and the encryption processing of the stored data.

FIG. 9 is a view describing an operation of changing the personal identification information according to the embodiment.

FIGS. 10A and 10B are views describing a method of data recovery according to the embodiment.

FIG. 11 is a view describing a method of setting a data encryption key to be usable by anybody along with a release of the user verification according to the embodiment.

FIG. 12 is a view describing a method to recover the stored data by use of a master key when a verification encryption key and a data encryption key are separately provided in the embodiment.

FIG. 13 is a view showing the concepts of the encryption and decryption processing in the ECB mode and the CBC mode.

FIG. 14 is a view schematically showing a data configuration of a sector corresponding to the encryption processing according to the embodiment.

FIG. 15 is a view showing aspects of sector data and flag bits when data reading and writing is executed in the state of turning off an encryption function of the hard disk device in the embodiment.

FIGS. 16A and 16B are views showing aspects of the sector data and the flag bits in another case when data reading and writing is executed in the state of turning on the encryption function of the hard disk device in the embodiment.

FIG. 17 is a view showing aspects of the sector data and the flag bits when data reading and writing is executed in the state where the encryption function of the hard disk device is once turned on and then turned off again.

FIG. 18 is a view showing a schematic configuration of a computer device including the hard disk device having the encryption function according to the present invention.

### DETAILED DESCRIPTION OF THE INVENTION

The present invention provides methods, systems and apparatus to achieve encryption processing of a stored data and management of an encryption key, which are suitable for the case when user verification and encryption of the stored data are applied to a storage device at the same time.

The present invention also provides a method of encryption processing for the stored data suitable for a detachably implemented storage device, and to provide a storage device which can achieve the method of encryption processing.

In an example embodiment, the present invention will be realized as a data storage device to be configured as follows. Specifically, the data storage device includes an encryption circuit for encrypting desired data and personal identification information by use of an encryption key created out of a given piece of the personal identification information such as a password; a recording medium for recording the data and the personal identification information which are encrypted by the encryption circuit, and a control unit for executing user verification by use of the encrypted personal identification information stored in the recording medium.

The encryption key may be further encrypted by use of another encryption key (a master key) and recorded in the recording medium. Alternatively, the encryption key may be recorded without encryption in a special storage area provided in the recording medium which is not accessible by normal use. In this way, even if the personal identification information is lost (such as the case when a user forgets a password), it is possible to decrypt and read the encrypted data by use of the encryption key saved in the recording medium.

Moreover, it is also possible to create a plurality of encryption keys out of a plurality of personal identification information, and to control the user verification and the data encryption depending on each of the plurality of encryption keys. In this case, the storage areas are managed in accordance with the plurality of keys and the encrypted data are recorded in the respective storage areas by use of the corresponding encryption keys. In this way, it is possible to verify respective users individually and to execute the encryption processing by use of the individual encryption keys when the data storage device is shared by the plurality of users.

Another data storage device according to the present invention encrypts desired data with an encryption circuit by use of a first encryption key, and encrypts the first encryption key and personal identification information by use of a second encryption key created out of a given piece of the personal identification information. Then, the data storage device records the data encrypted by use of the first encryption key, the first encryption key encrypted by use of the second encryption key, and the personal identification information encrypted by use of the second key in a recording medium. Moreover, the control unit executes user verification by use of the encrypted personal identification information stored in the recording medium. Here, the first encryption key may be created out of the personal identification information as similar to the second key, or alternatively, arbitrary information such as a random number sequence may be set up and used as the first encryption key. In such a configuration, the encryption circuit decrypts the encrypted first encryption key being read out of the recording medium by use of the second encryption key, and thereby encrypts or decrypts the desired data by use of the decrypted first encryption key.

As described above, although the higher encryption key is changed if the encryption keys are multiple-layered and the higher encryption key is created out of the personal identification information so as to change the personal identification information for enhancing security, it is not necessary to change the lower encryption key which is encrypted by use of the higher encryption key. That is, it is possible to deal with the change of the personal identification information just by encrypting the lower encryption key again with the changed higher encryption key, and it is not necessary to encrypt the data again which are encrypted by the lower encryption key.

Meanwhile, the present invention is also realized as a data storage device to be configured as follows. Specifically, the data storage device includes a magnetic disk, a read-and-write mechanism for reading and writing data, and a control mechanism which has an encryption function for encrypting data to be written in the magnetic disk and for decrypting the encrypted data to be read out of the magnetic disk, and controls reading and writing of the data by the reading-and-writing mechanism. Moreover, upon processing of writing the data in the magnetic disk, the control mechanism executes encryption of the data to be written in the magnetic disk for each unit of writing and reading data in and out of a storage area of the magnetic disk in response to turning on and off of the encryption mechanism. Here, the unit of data writing and reading in and out of the storage area of the magnetic disk may be defined as equivalent to a sector, a logical block, or the like. Moreover, upon reading the data out of the storage medium, the control mechanism judges as to whether the data are encrypted or not, and further controls decryption when the data are encrypted.

Meanwhile, another way of attaining the foregoing aspects is also realized as a data processing method for executing data writing and reading in and out of a recording medium of a data storage device, which is configured as follows. Specifically, the data processing method includes the steps of creating an encryption key by converting a given piece of personal identification information with an encryption function or a one-way function, encrypting the personal identification information by use of the created encryption key and thereby recording the encrypted personal identification information in a recording medium as verification data, executing user verification based on the verification data, and encrypting write data transmitted from a host system by use of the previously created encryption key and thereby recording the encrypted write data in the recording medium or decrypting the data read out of the recording medium by use of the encryption key and thereby transmitting the decrypted data to the host system.

Moreover, another data processing method according to the present invention includes the steps of creating an verification encryption key out of a given piece of personal identification information, encrypting the personal identification information by use of the verification encryption key and thereby recording the encrypted personal identification information in a recording medium as verification data while encrypting a data encryption key by use of the verification encryption key and thereby recording the encrypted data encryption key in the recording medium, executing user verification based on the verification data, decrypting the data encryption key by use of the verification encryption key, and encrypting write data transmitted from a host system by use of the decrypted data encryption key and thereby recording the encrypted write data in the recording medium or decrypting the data read out of the recording medium by use of the data encryption key and thereby transmitting the decrypted data to the host system.

Moreover, the present invention is also realized as a program which controls a computer to execute processing which corresponds to the respective steps of any of the above-described data processing methods.

Furthermore, the present invention can be also realized as an information processing device which incorporates and use any of the above-described data storage devices as an external storage device.

Now, the present invention will be described in detail based on embodiments as illustrated in the accompanying drawings. Although the present invention refers to encryption technology which is applicable to various types of external storage devices including magnetic disk devices (such as hard disk devices), optical disk devices, memory cards and the like, description will be made in this embodiment regarding application to a hard disk device as an example.

A hard disk device is used as an external storage device for a personal computer, a workstation, or any other computer device (an information processing device).

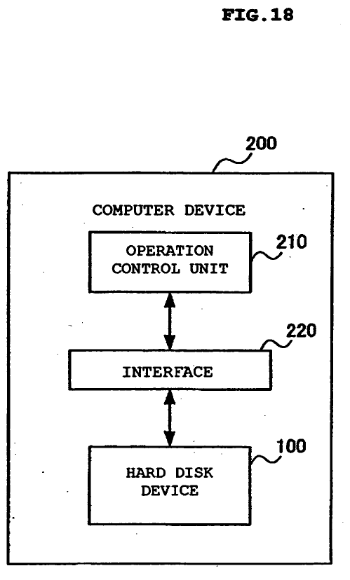

FIG. 18 is a view showing a schematic configuration of a computer device including the hard disk device as the external storage device.

As shown in FIG. 18, a computer device 200 includes an operation control unit 210 realized by a central processing unit (CPU) and an internal memory such as a random access memory (RAM), and an interface 220 (such as an AT attachment (ATA) or a small computer system interface (SCSI)) for accessing a hard disk device 100 which is an external storage device. The computer incorporates the hard disk device 100 as the external storage device. The hard disk device 100 stores (writes) and transfers (reads) data in accordance with control by the operation control unit 210 of the computer device 200. Here, although illustration is not specifically made in the drawing, it is obvious that the computer device 200 is actually configured by including inputting means such as a keyboard or a mouse for inputting the data or commands, and outputting means such as a display device for outputting processing results, and the like.

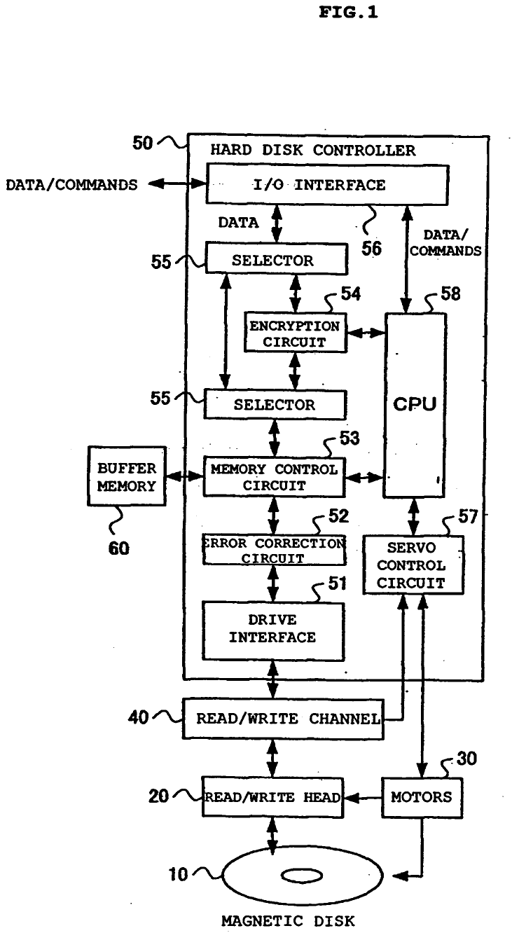

FIG. 1 is a view showing a configuration example of the hard disk device 100 of this embodiment.

With reference to FIG. 1, the hard disk device 100 includes a magnetic disk 10, which is a recording medium. Moreover, the hard disk device 100 also includes a read/write head 20, a spindle motor for rotating the magnetic disk 10 and a voice coil motor for seeking the read/write head 20 (which are collectively denoted as the motors 30 in the drawing), and a read/write channel 40 for executing data reading and writing processing by modulating and demodulating data (signals) for writing and reading in and out of the magnetic disk 10 through the read/write head 20, collectively as a read-and-write mechanism for data writing and reading in and out of the magnetic disk 10. Furthermore, the hard disk 100 also includes a hard disk controller 50 for supervising and controlling operations of the hard disk device 100, and a buffer memory 60, collectively as a control mechanism.

The hard disk controller 50 includes a drive interface 51 for exchanging data with the read/write channel 40, an error correction circuit 52 for correcting a reading error in the data read out of the magnetic disk 10, a memory control circuit 53 for accessing the buffer memory 60, an encryption circuit 54 and a selector 55 for encrypting and decrypting the data to be read out of and written into the magnetic disk 10, an I/O interface 56 for exchanging the data and commands with the computer device 200 being the host system, a servo control circuit 57 for performing servo control based on servo signals read out of the magnetic disk 10 with the read/write head 20, and a CPU 58 as a control unit for performing operation control of the respective circuits.

In the above-described configuration, when data are written in the magnetic disk 10, a write request command transmitted from the computer device 200 is firstly received by the CPU 58 through the I/O interface 56, and then the following operations are conducted under the control by the CPU 58. Specifically, write data transmitted from the computer device 200 after the write request command are inputted through the I/O interface 56 and are encrypted by the selector 55 and the encryption circuit 54 as appropriate, and then are transmitted from the drive interface 51 to the read/write channel 40 through buffering by the memory control circuit 53 and the buffer memory 60. Thereafter, the data are magnetically written in the magnetic disk 10 with the read/write head 20. Here, physical operations such as seeking with the read/write head 20 or rotation of the magnetic disk 10 are controlled by CPU 58 through the servo control circuit 57 and the motors 30. Details of the control for the encryption processing by the selector 55 and the encryption circuit 54 will be described later.

Meanwhile, when the data are read out of the magnetic disk 10, a read request command transmitted from the computer device 200 is firstly received by the CPU 58 through the I/O interface 56, and then the following operations are executed under the control by the CPU 58. Specifically, operations of the read/write head 20 and the magnetic disk 10 are controlled by the servo control circuit 57 and the motors 30, and thereby the data recorded in a desired area of the magnetic disk 10 are read out. The data thus read out are transmitted to the hard disk controller 50 through the read/write channel 40, and are further transmitted to the error correction circuit 52 through the drive interface 51. After errors such as garbled bits are corrected by the error correction circuit 52, the data are decrypted by the selector 55 and the encryption circuit 54 as appropriate and then transmitted to the computer device 200 through the I/O interface 56. Details of the control for the decryption processing by the selector 55 and the encryption circuit 54 will be described later.

In this embodiment, encryption of the data to be written in the magnetic disk 10 and decryption of the data to be read out of the magnetic disk 10 are controlled by use of the encryption circuit 54 and the selector 55 which are under control of the CPU 58.

The encryption circuit 54 encrypts the data and decrypts the encrypted data by use of an encryption algorithm. The selector 55 selects as to whether or not the write data or the read data are subjected to processing by the encryption circuit 54.

The processing by the encryption function of this embodiment is divided broadly into two categories of: (A) processing concerning management of an encryption key when user verification and encryption of the stored data are applied at the same time; and (B) processing concerning control for encryption and decryption of the stored data to be written in the magnetic disk 10. Description will be made below regarding each of the categories.

A. Processing Concerning Management of an Encryption Key

In this processing, the same encryption algorithm is used for the user verification and the encryption processing of the stored data. Specifically, the encryption key for use in encryption and decryption of the stored data is created by converting the personal identification information used for the user verification with an encryption function or a one-way function. Then, the encryption circuit 54 further encrypts the personal identification information by use of this encryption key, and the encrypted personal identification information (hereinafter referred to as the “verification data”) are written and saved in the magnetic disk 10. Upon the user verification, the CPU 58 firstly requests input of the personal identification information, then converts the personal identification information inputted to the encryption circuit 54 with the same encryption algorithm. Thereafter, the CPU 58 judges as to whether or not the converted data match the verification data written in the magnetic disk 10, and identifies the qualified user based on a result of the judgment. Even if the verification data written in the magnetic disk 10 are illegally read out, the original personal identification information will not be obtained because of the one-way property of the encryption processing (that the original data cannot be obtained without the encryption key).

Here, in addition to a password in a password lock function to be included in the hard disk device 100 as a standard equipment, a variety of information can be used as the personal identification information, such as a character string of an arbitrary length, ID information recorded in an IC card or the like, or biological information according to biometrics by use of fingerprints and the like.

Now, the respective operations of the method of the present invention will be separately described.

1. Initial Setting (Creation of the Encryption Key and Saving the Verification Data)

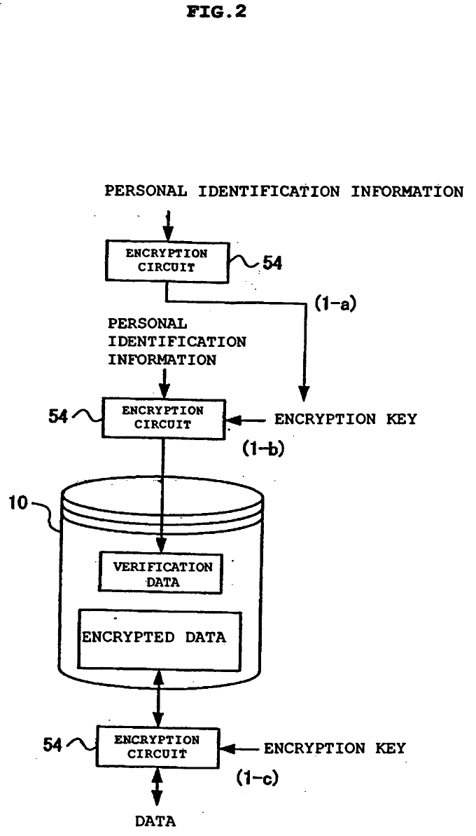

FIG. 2 is a view describing the method of initial setting of the user verification.

As shown in FIG. 2, the encryption key is firstly created by encrypting the personal identification information with the encryption circuit 54 (1-a). When the data length of the personal identification information is too short, such a shortage can be padded with appropriate data. On the contrary, when the data length of the personal identification information is too long, the encryption can be compressed to a desired key length by use of common key encryption in a message verification code (MAC) mode, which is a feedback mode. Moreover, as for the encryption key to be used in such encryption, it is possible to use a part of the personal identification information or appropriate key information (data) may be set up instead.

Next, the personal identification information is encrypted again and thereby converted into the verification data with the encryption circuit 54 by use of the encryption key created in the processing (1-a), and then the verification data are written in the magnetic disk 10 (1-b). It is also possible to divide the personal identification information in two pieces and each piece may be provided for creation of the encryption key and for creation of the verification data, as long as input of the personal identification information of a sufficient data length is ensured.

From that time on, the encryption key created in the processing (1-a), which is used for creation of the verification data, will be used for encryption and decryption of the data to be written in and read out of the magnetic disk 10 by the encryption circuit 54 (1-c).

2. The User Verification and the Encryption Processing of the Stored Data

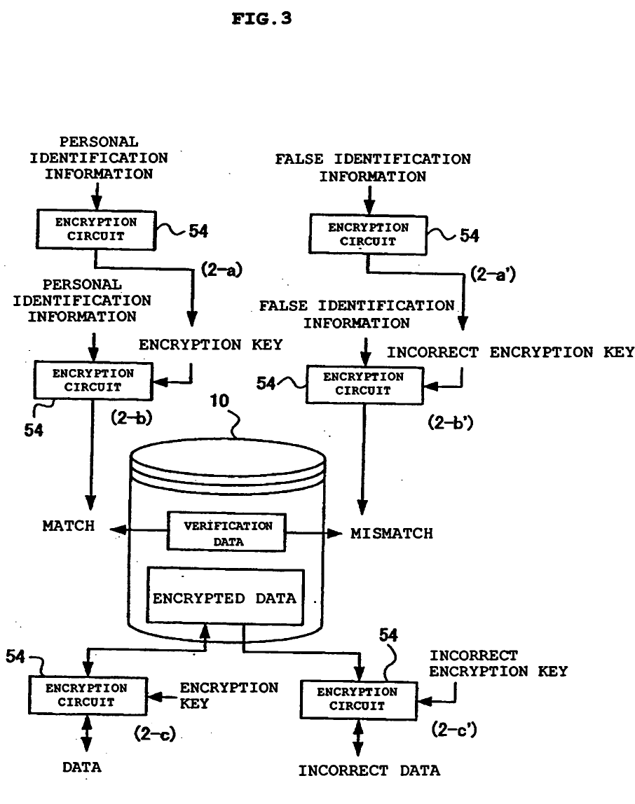

FIG. 3 is a view describing a method of the user verification and the encryption processing of the stored data.

As shown in FIG. 3, the personal identification information is firstly inputted and then encrypted by the encryption circuit 54, whereby the encryption key is created (2-a). Then, the personal identification information is encrypted again with the encryption circuit 54 by use of this encryption key, and the verification data are created (2-b). When the inputted personal identification information is correct (in other words, when the inputted personal identification is identical to the personal identification information which was used upon creation of the encryption key and the verification data in the initial setting described with reference to FIG. 2), the created verification data match the verification data that are recorded in the magnetic disk 10. Accordingly, the verification succeeds in the verification processing by the CPU 58 and the hard disk device 100 is thereby activated. Then, either encryption of the data to be transmitted from the computer device 200 and to be written in the magnetic disk 10, or decryption of the data read out of the magnetic disk 10 and to be transmitted to the computer device 200 is executed by the encryption circuit 54 (2-c).

On the contrary, when the inputted personal identification information is wrong (in other words, when the inputted personal identification is not identical to the personal identification information which was used upon creation of the encryption key and the verification data in the initial setting described with reference to FIG. 2), the created verification data do not match the verification data that are recorded in the magnetic disk 10. Accordingly, the verification fails and the hard disk device 100 is thereby locked (to an inaccessible state) (2-a′) (2-b′). Therefore, data reading or writing in and out of the magnetic disk 10 are unable. Even if the encrypted stored data in the magnetic disk 10 are read out somehow or other, the data cannot be decrypted because the correct encryption key is not created (2-c′). In addition, it is not possible to restore the encryption key or the personal identification information out of the encrypted verification data stored in the magnetic disk 10 because of the one-way property of the encryption processing.

3. Recovery of the Stored Data

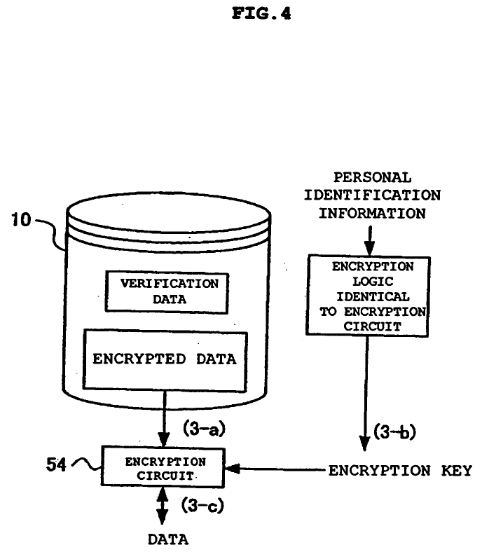

FIG. 4 is a view describing a method to recover the stored data when a trouble occurs in the magnetic disk 10.

When a trouble occurs in the magnetic disk 10, if it is possible to read the stored data at least partially (3-a) as shown in FIG. 4, an encryption key is created out of the personal identification information by use of encryption software or the like (3-b) based on an algorithm as similar to the encryption processing by the encryption circuit 54, so that the data in the read-out portion can be restored (3-c).

In this embodiment, safety of the encrypted stored data will not be damaged even if the algorithms for the verification and the encryption are disclosed. This is because the encrypted data are protected by the encryption key which is created out of the personal identification information of the respective users. In other words, it is impossible to decrypt the encrypted data unless the encryption key created out of the personal identification information in accordance with the above-described procedures (see the operations 1 and 2) is used. Accordingly, it is not possible to recover the personal identification information or the original data out of the verification data or the encrypted data. Therefore, in the case of a breakdown of the hard disk device 100 or the like, there is no concern that a third party obtains the contents of the stored data even if the user asks the third party to cancel the lock for the user verification and to read the data.

Here, when a trouble occurs in a mechanical portion other than the magnetic disk 10, such as in a circuit on a board, it is possible to recover from such a trouble without reading the data for restoration as described above, but just with setting the relevant magnetic disk 10 onto another hard disk device 100.

4. Recovery of the Stored Data Using a Master Key

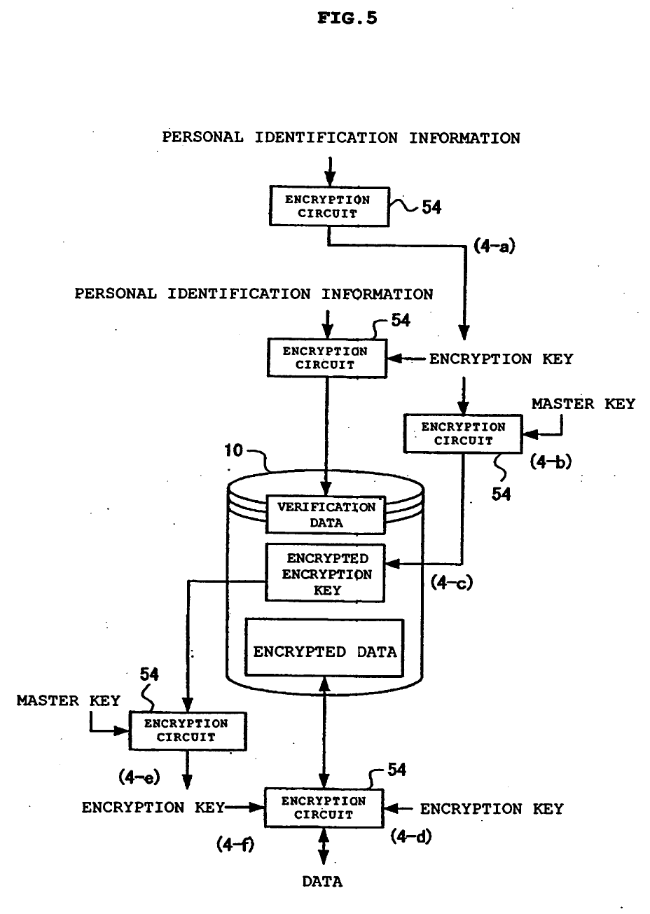

FIG. 5 is a view describing a method to recover the stored data by use of a master key.

As shown in FIG. 5, the personal identification information is firstly encrypted by the encryption circuit 54, and the encryption key is thereby created (4-a). Then, this encryption key is encrypted by use of a separately created master key (4-b), and is written and saved in the magnetic disk (4-c). The stored data are encrypted or decrypted (4-d) by use of the encryption key, which is created in the processing (4-a).

When the encrypted encryption key is saved in the magnetic disk 10 as described above, the encryption key can be restored by use of the master key (4-e) even if the use loses the personal identification information (such as the case when the user forgets the password). Accordingly, it is possible to read and decrypt the encrypted stored data (4-f)

It is conceivable that this master key is created and preserved by the manufacturer of the hard disk device 100 for use in repair and maintenance of the product. Note that security of the stored data is relatively decreased in this case, because the owner of the master key is able to access the stored data which are encrypted by the user. Meanwhile, if the hard disk device 100 is completely locked by the personal identification information, there is no chance to read the encrypted data upon a failure and the like of the hard disk device 100. Accordingly, it is also important to provide various security level options to be flexibly set in response to the request of the user, such as an option not to allow the lock by the user verification upon encryption of the stored data or an option to allow the master key solely to release the lock by the user verification.

5. Multiple Setting of the Verification Data

Upon a failure of the hard disk device 100, it is necessary to cancel the lock function of the hard disk device 100 for a failure analysis irrespective of the recovery of the stored data. Therefore, it is convenient if separate verification data for canceling the lock of the hard disk device 100 in addition to the verification data used for locking the hard disk device 100 and for the encryption of the stored data (the verification data created out of the personal identification data).

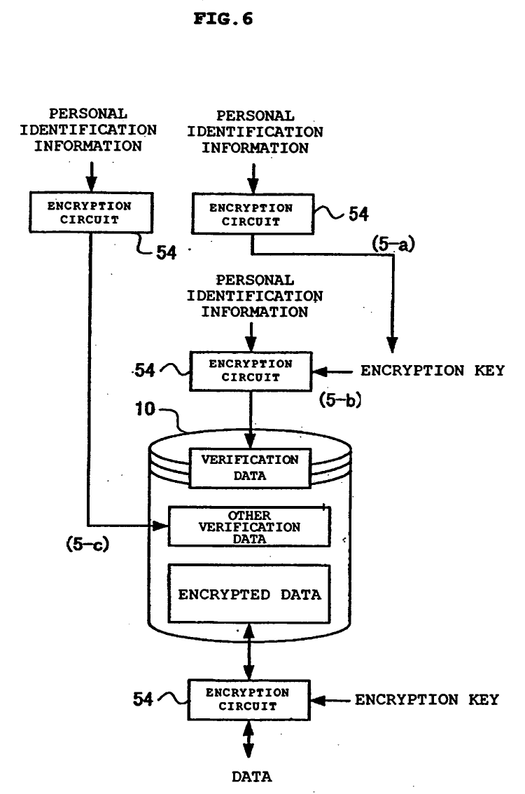

FIG. 6 is a view describing a method of setting the verification data for canceling the lock of the hard disk device 100 in addition to the verification data according to the personal identification information.

As shown in FIG. 6, in addition to the processes in the operation 1 where the encryption key is created out of the personal identification information (5-a) and the verification data are created (5-b), verification information different from the personal identification information is encrypted by the encryption circuit 54 and is written and saved in the magnetic disk 10 as other verification data (5-c). The user verification using the verification data is executed by the CPU 58 as similar to the operation 2.

Since the verification data are not related to the encryption key, the verification data cannot recover the stored data unlike the master key described in the operation 4. Therefore, there is no risk of leakage of the contents in the stored data even if a third party possesses the verification information. In addition, it is also useful to prepare a plurality of pieces of the verification data and the encryption keys in order to share the hard disk device 100 with a plurality of users or to allow the manufacturer of the hard disk device 100 to secure an exclusive data area for the system on the magnetic disk 10. In this case, the storage area of the magnetic disk 10 is managed depending on the respective pieces of the verification data or the respective encryption keys, or the storage area of the magnetic disk 10 is physically divided (into partitions, for example), whereby the user verification and the encryption processing are individually controlled. In other words, the data encrypted by the encryption key are written in the corresponding storage area out of the storage areas which are managed depending on the verification data and the encryption keys.

6. Support To a Change in the Personal Identification Information

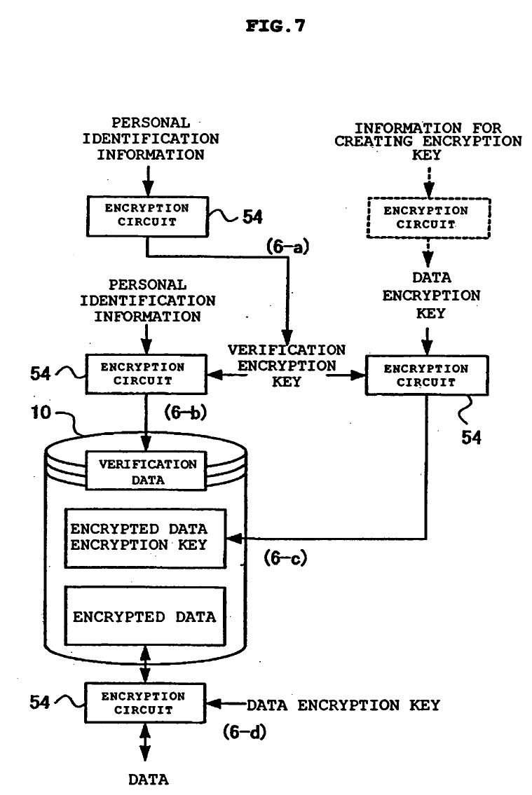

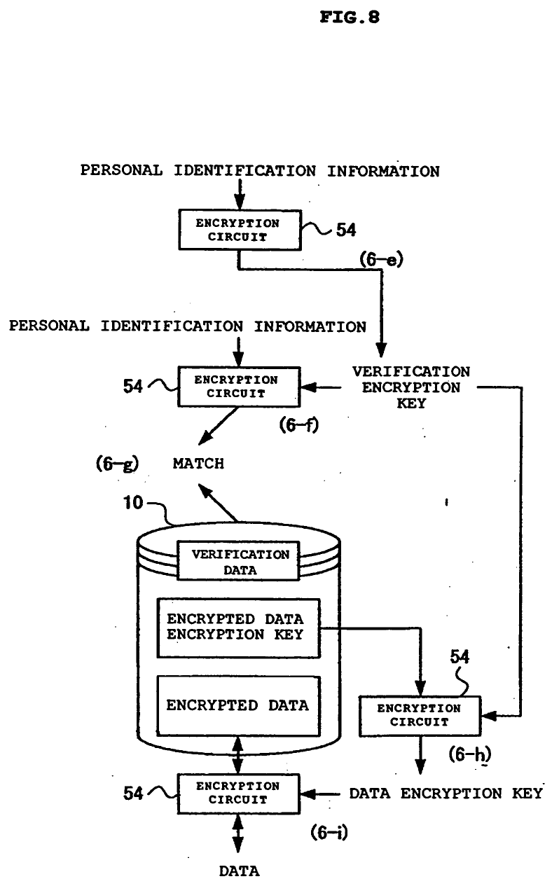

FIG. 7 and FIG. 8 are views describing a method for the encryption processing in a case of changing the personal identification information.

Upon the user verification, it is suggested to change the personal identification information for verification periodically or at random to enhance the security. However, when the stored data are simply encrypted by use of the encryption key which is created out of the personal identification information, the encryption will be changed if the personal identification information is changed. Accordingly, it is necessary to execute the processing of decrypting the stored data with the encryption key created out of the personal identification information prior to the change and then encrypting the stored data again with an encryption key created out of the new personal information. The storage capacity of the hard disk device 100 is increasing these days, and there may be a case where data exceeding 100 GB are stored therein. Accordingly, it will take a lot of time for decryption and re-encryption of such huge data. Therefore, a data encryption key used for the encryption processing of the stored data is encrypted and saved by use of the verification encryption key which is created by encrypting the personal identification information. In this way, it is possible to the change in the personal identification information without degrading the security. Here, the encryption key described in the operations 1, 2 and the like is deemed to be the case where the data encryption key and the verification encryption key described herein are identical to each other (not that the encryption key is not saved in the magnetic disk 10 at the initial setting of the operation 1).

An operation at the initial setting will be described with reference to FIG. 7.

As shown in FIG. 7, the personal identification information is firstly encrypted by the encryption circuit 54, whereby the verification encryption key is created (6-a). Then, the personal identification information is encrypted again by use of this verification encryption key, and the encrypted personal identification information is written and saved in the magnetic disk 10 as the verification data (6-b). Similarly, the data encryption key is encrypted by use of this verification encryption key, and the encrypted data encryption key is written and saved in the magnetic disk 10 (6-c). In this operation 6, the data encryption key exclusive for the data encryption processing is used for encryption of the read data and decryption of the write data (6-d), instead of the verification encryption key created out of the personal identification information in the processing (6-a). As similar to the verification encryption key and the above-described operations 1, 2 and the like, this data encryption key may be created by encrypting given information for creation of the encryption key with the encryption circuit 54, or arbitrary key information (such as a random number sequence) may be set up and used as the encryption key. Moreover, it is also possible to create the data encryption key by encrypting the same personal identification information as the verification encryption key by use of an encryption function or a one-way function which is different from one used upon creation of the verification encryption key. Here, when the mutually different verification encryption key and the data encryption key are created out of the personal identification information by use of different operations (functions), it is possible to create the correct data encryption key if the personal identification information is correct. Accordingly, it is not necessary to encrypt the data encryption key with the verification encryption key and to save the data encryption key in the magnetic disk 10.

Next, description will be made regarding the user verification and the encryption processing of the stored data with reference to FIG. 8.

As shown in FIG. 8, the personal identification information is firstly encrypted by the encryption circuit 54, whereby the verification encryption key is created (2-e). Then, the personal identification information is encrypted again by use of this verification encryption key, and the verification data are created (6-f). When the created verification data are identical to the verification data recorded in the magnetic disk 10, the verification succeeds in the verification processing by the CPU 58 and the hard disk device 100 is thereby activated (6-g). Moreover, the encrypted data encryption key is read out of the magnetic disk 10 and is decrypted with the encryption circuit 54 by use of the verification encryption key (6-h). Then, either encryption of the data to be transmitted from the computer device 200 and to be written in the magnetic disk 10, or decryption of the data read out of the magnetic disk 10 and to be transmitted to the computer device 200 is executed by the encryption circuit 54 using the data encryption key (6-i).

When the encryption processing for the stored data is performed as shown in FIG. 7 and FIG. 8, even if the personal identification information is changed, it is only necessary to create verification data again out of new personal identification information and to encrypt a data encryption key again with a new verification encryption key to be created out of the new personal identification information. In other words, it is not necessary to encrypt the entire stored data again. Therefore, it is possible to respond with realistic processing if a large amount of the stored data are recorded in the magnetic disk 10.

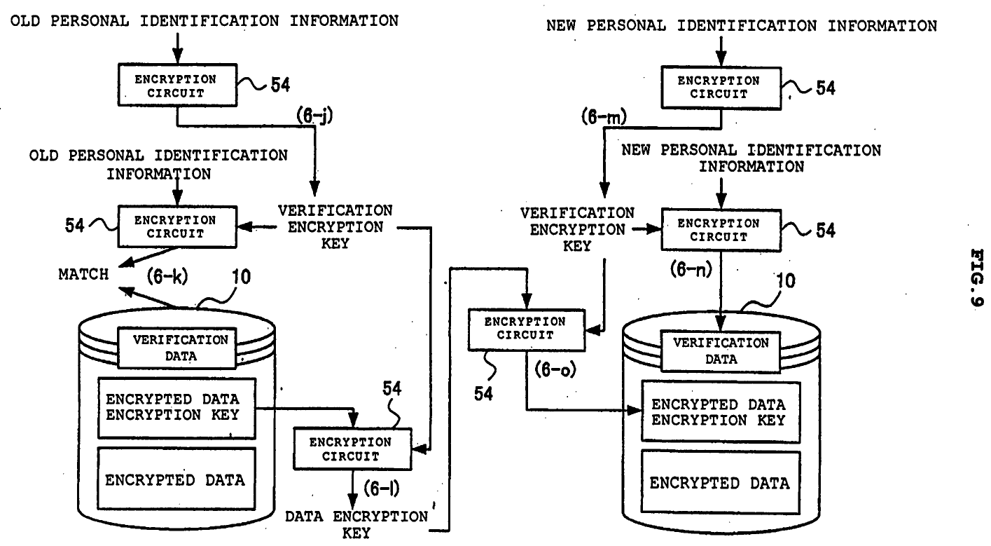

FIG. 9 is a view describing an operation of changing the personal identification information.

As shown in FIG. 9, the verification encryption key is firstly created out of the personal identification information before the change by the encryption circuit 54 (6-j), and the verification data are created out of the personal identification information by use of this verification encryption key. Then, the created verification data are verified with the verification data recorded in the magnetic disk 10 by the CPU 58 (6-k). After the verification is completed, the encrypted data encryption key recorded in the magnetic disk 10 is read out and decrypted with the encryption circuit 54 by use of the verification encryption key (6-l).

Meanwhile, the new verification encryption key is created out of the new personal identification information (6-m), and the personal identification information is encrypted again by use of the new verification encryption key, whereby the encrypted personal identification information is written and saved in the magnetic disk 10 as the new verification data (6-n). Thereafter, the data encryption key being decrypted previously is encrypted again with the encryption circuit 54 by use of the new verification encryption key, and the encrypted data encryption key is written and saved in the magnetic disk 10 (6-o).

Moreover, when the encryption processing for the stored data is performed as shown in FIG. 7 and FIG. 8, even if the hard disk device 100 is failed, it is still possible to decrypt the stored data with the data encryption key and thereby obtain the desired data as long as the encrypted stored data can be read out of the magnetic disk 10, either by obtaining the data encryption key as similar to the encryption of the stored data, or by creating the verification encryption key out of the personal identification information and then restoring the data encryption key.

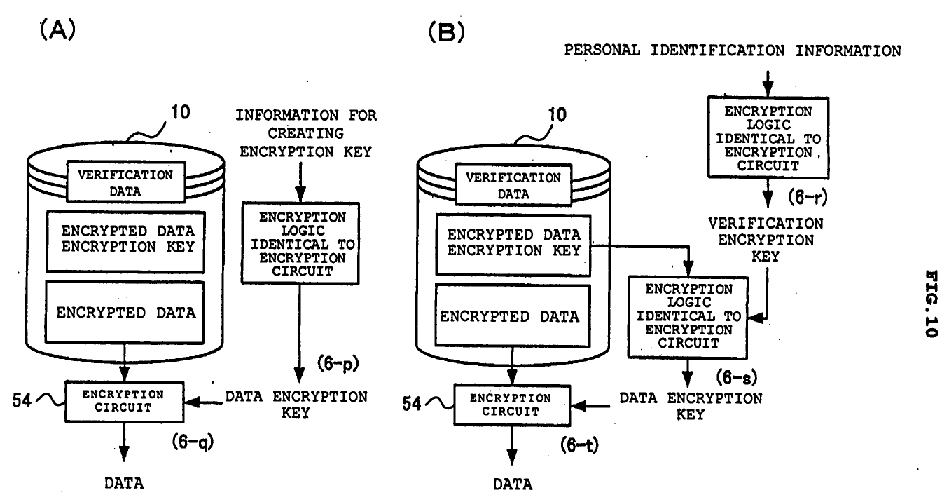

FIGS. 10A and 10B are views describing a method of data recovery.

If the data encryption key is created by encrypting the information for creation of the encryption key with the encryption circuit 54, as shown in FIG. 10A, it is possible to create the data encryption key again by encrypting the same information by use of the same encryption logic as that of the encryption circuit 54 (6-p). Then, the stored data read out of the magnetic disk 10 are decrypted by use of this data encryption key (6-q).

Meanwhile, the verification encryption key is created by encrypting the personal identification information by use of the same encryption logic as that of the encryption circuit 54 (6-r). Therefore, if the encrypted data encryption key can be read out of the magnetic disk 10, as shown in FIG. 10B, the data encryption key is decrypted by use of this verification encryption key (6-s). Thereafter, the stored data read out of the magnetic disk 10 are decrypted by use of this data encryption key (6-t).

7. Cancel of the User Verification

A command to clear the password is set as standard equipment on the hard disk device 100 having the password lock function. After execution of this command, it is essential that anybody can read and write the contents in the disk. However, if the stored data in the magnetic disk 10 are encrypted, the entire decryption of the encrypted stored data and rewriting of the decrypted data in the magnetic disk 10 along with the cancel of the user verification require a lot of time and are therefore impractical. Therefore, when the user verification is canceled, the encryption key to be used for the encryption processing of the stored data is written in the magnetic disk 10, so that the encryption key can be used by anybody at any time (without the verification) upon reading the stored data.

When the encryption processing for the stored data is performed as shown in FIG. 7 and FIG. 8, the encrypted data encryption key is saved in the magnetic disk 10. Therefore, anybody can freely use the data encryption key by decrypting the data encryption key and writing the data encryption key in the magnetic disk 10.

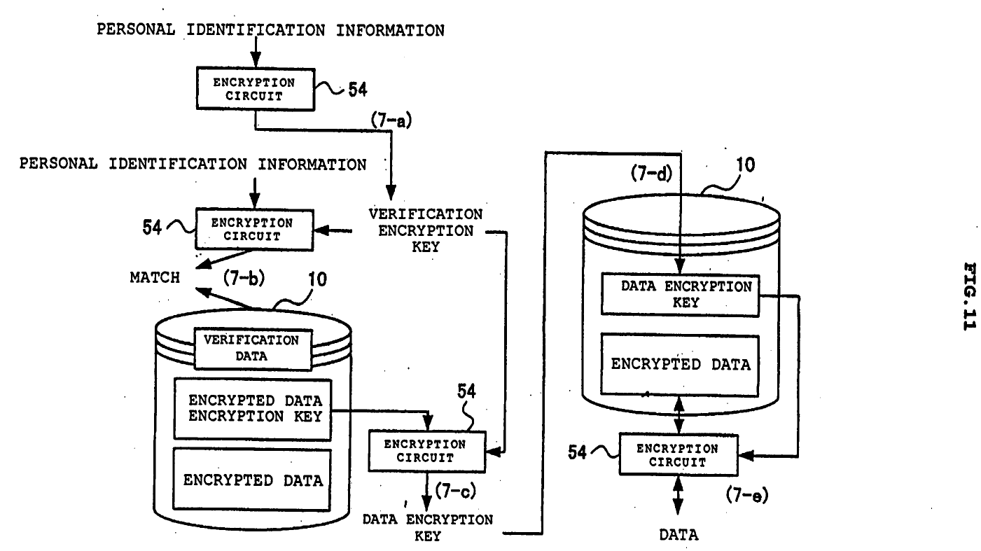

FIG. 11 is a view describing a method of setting the data encryption key to be usable by anybody along with the cancel of the user verification.

As shown in FIG. 11, the verification encryption key is firstly created out of the personal identification information before the change by the encryption circuit 54 (7-a), and the verification data are created out of the personal identification information by use of this verification encryption key. Then, the created verification data are verified with the recorded verification data recorded in the magnetic disk 10 by the CPU 58 (7-b). After the verification is completed, the encrypted data encryption key recorded in the magnetic disk 10 is read out and decrypted with the encryption circuit 54 by use of the verification encryption key (7-c). Then, the decrypted data encryption key is written in the magnetic disk 10 again (7-d). Thereafter, the data encryption upon data reading and writing becomes possible by use of the data encryption key written in the magnetic disk 10 (7-e).

After the encryption key (the data encryption key) is rendered freely usable by anybody as described above, if the encryption in the event of writing the data in the magnetic disk 10 and the decryption in the event of reading the data out of the magnetic disk 10 are automatically performed under the control by the CPU 58, the user can read and write the data in and out of the magnetic disk 10 without recognition that the stored data are encrypted. Moreover, it is also possible to control not to encrypt the data which will be written in the magnetic disk 10 after the user verification is canceled. In this case, in order to judge as to whether the processing by the encryption circuit 54 is executed or not upon reading or writing the stored data in accordance with encryption or unencryption of the stored data, it is necessary to distinguish the encrypted stored data and the unencrypted stored data by means of adding flag bits or the like.

When the user verification is canceled as described above, the unencrypted encryption key (the data encryption key) is temporarily recorded in the magnetic disk 10 during a series of processing of “setting the user verification”—“canceling the user verification”—“setting the user verification”. Therefore, if the encryption key is read out by a third party in this event, the third party may be able to decrypt the stored data in the magnetic disk 10 by use of the encryption key. However, since a special storage area which is not normally accessible by the user is provided on the magnetic disk 10 in the usual hard disk device 100. Accordingly, upon recording the unencrypted encryption key, it is possible to avoid the encryption key from being easily read out by the third party if the special storage area is used.

Nevertheless, it is still possible to read the data written in the relevant storage area by use of a special measuring device. Accordingly, there remains a risk that the stored data would be decrypted by the third party if the hard disk device 100 itself falls into the hand of the third party.

The following case is conceivable as a concrete example.

Here, an assumption is made that a malicious third party passes a hard disk device 100 to a target user who intends to steal data for, and that the third party acquired an unencrypted encryption key (a data encryption key) for the hard disk device 100 beforehand by the procedures of “setting the user verification”—“canceling the user verification”—“setting the user verification”. In this case, the data stored in the hard disk device 100 by the target user can be decrypted by use of the encryption key acquired by the malicious third party even if the data are encrypted.

However, it is easy to check as to whether or not cancel or setting of user verification has been executed on the hard disk device 100 after shipment. Accordingly, if a risk of such data theft becomes apparent as a result of the check, it is possible to cope with the risk by formatting a magnetic disk 10 again or by re-encrypting the encrypted data with a new encryption key, although such measures are somewhat time-consuming.

8. Recovery of the Stored Data Using a Master Key

Instead of encrypting the data encryption key by use of the verification encryption key as described in the operation 6, it is also possible to encrypt the data encryption key by use of a master key and to save the encrypted data encryption key in the magnetic disk 10.

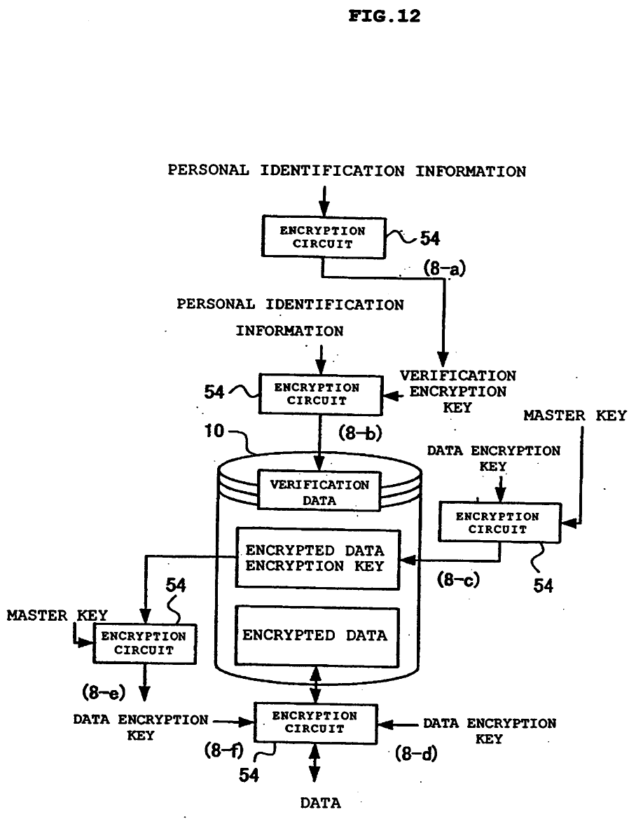

FIG. 12 is a view describing a method to recover the stored data by use of the master key.

As shown in FIG. 12, the personal identification information is firstly encrypted by the encryption circuit 54, whereby the verification encryption key is created (8-a). Then, the verification data are created by encrypting the personal identification information again with the encryption circuit 54 by use of this verification encryption key, and the verification data are written and saved in the magnetic disk 10 (8-b). Meanwhile, the data encryption key is encrypted by use of a separately created master key, and the encrypted data encryption key is written and saved in the magnetic disk 10 (8-c). The data encryption key is used for encryption and decryption of the stored data (8-d). As similar to the operation 6, the data encryption key may be created by encrypting given information for creation of the encryption key with the encryption circuit 54, by setting arbitrary key information such as a random number sequence, or by encrypting the personal identification information with a function which is different from the one used upon creation of the verification encryption key.

If the encrypted data encryption key created as described above is saved in the magnetic disk 10, the data encryption key can be restored by use of the master key (8-e). Accordingly, an owner of the master key can read and decrypt the encrypted stored data freely (8-f) even if the user does not decrypt the data encryption key or save the decrypted encryption key in the magnetic disk 10 as described in the operation 7.

B. Processing Concerning Control for Encryption and Decryption of the Stored Data

In this processing, encryption processing on data is controlled for each unit of writing and reading the data in and out of the recording medium in response to turning on and off of the encryption function of the hard disk device 100. The unit of reading and writing the data may be defined as a sector or a logical block to be set in the storage area of the magnetic disk 10, for example. In the following, description will be made regarding the case where the encryption is controlled depending on sectors. Here, switching work for turning the encryption function on and off in the hard disk device 100 can be executed, for example, by means of issuing a switching command from the computer device, the host system, through a hard disk driver or the like. Meanwhile, it is also possible to switch the encryption function on and off by use of a physical switch (such as a jumper switch) provided on a hard ware casing.

The processing unit in a common key encryption method which is widely used for data encryption is normally either a 64-bit or 128-bit basis. In this case, a disk sector in the size of 512 bytes (4096 bits) will be divided into 64 or 32 blocks for the encryption processing. Typical use modes of the encryption include the electronic code book (ECB) mode and the cipher block chaining (CBC) mode.

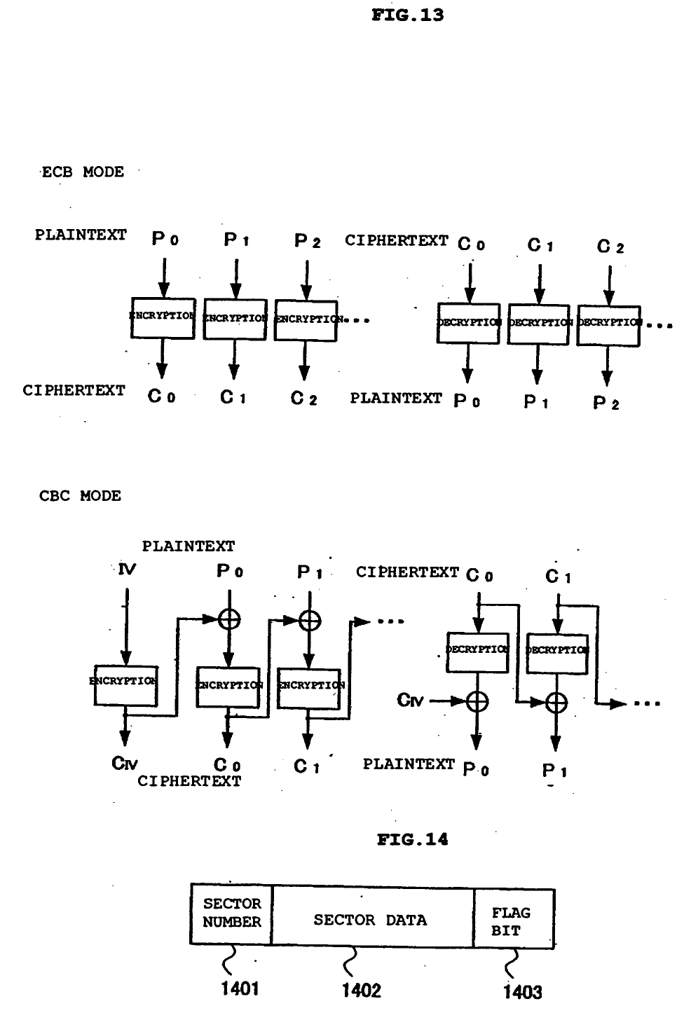

FIG. 13 is a view showing the concepts of the encryption and decryption processing in the ECB mode and the CBC mode.

As shown in FIG. 13, when plaintext (unencrypted data) blocks Pᵢ (i=0, 1, 2, and so on) created by dividing the sectors are encrypted in the ECB mode, it is impossible to find the original plaintext block Pᵢ by calculation out of a corresponding ciphertext block Cᵢ. However, since 64-bit or 128-bit ciphertext blocks of the same values correspond to the plaintext of the same values, information as to which pieces of data are identical to each other becomes disclosed.

For this reason, the CBC mode is applied to the case of encrypting data having a considerable data length. The CBC is an encryption mode which applies continuous calculation of an exclusive OR (XOR) of an object data block and a previous data block. Upon encryption in the CBC mode as shown in FIG. 13, the plaintext block Pᵢ is encrypted after the XOR operation with the previous encrypted block Cᵢ₋₁. In this way, the same plaintext blocks will be converted into different ciphertext blocks.

In the CBC mode, the initial plaintext block P₀ does not have a ciphertext block targeted for the XOR operation. In this case, typically, an appropriate data piece called an initial vector (IV) is encrypted to create a pseudo-random number C_{IV}, and then the pseudo-random number C_{IV} is subjected to the XOR operation with the plaintext block P₀. In this embodiment, a sector number for identifying each sector will be used as this initial vector. Here, in the case of the encryption processing of the data by a unit other than the sector, information for specifying the unit may be used as the initial vector (for example, a logical block address (LBA) may be used when a logical block is defined as the unit of the encryption processing).

FIG. 14 is a view schematically showing a data configuration of the sector corresponding to the encryption processing of this embodiment.

With reference to FIG. 14, each sector records a sector number 1401 for identifying an individual sector, sector data 1402 being the stored data, and a flag bit 1403 being a control flag indicating as to whether the sector data 1402 are encrypted or not.

Here, the flag bit 1403 of the sector including the unencrypted sector data 1402 will be set to “0”, and the flag bit 1403 of the sector including the encrypted sector data 1402 will be set to “1”. Therefore, the flag bits 1403 of the respective sectors in the magnetic disk 10 will be reset to “0” in an initial state, such as a point of shipment, of the hard disk device 100 because the encryption function is turned off.

In this embodiment, the two following types of control will be executed upon the encryption processing of the stored data. Specifically, in the data writing processing, control is made as to whether or not the data to be written in the magnetic disk 10 are encrypted in response to turning on and off of the encryption function in the hard disk device 100. Meanwhile, in the data reading processing, the data being read out are decrypted when the stored data are the encrypted data (when the values of the flag bits 1403 are set to “1”).

In the hard disk device 100 shown in FIG. 1, the selector 55 checks turning on and off of the encryption function and the value of the flag bit 1403 regarding each piece of the read and write data in each sector, and the selector 55 can judge as to whether or not encryption of the write data or decryption of the read data should be executed by the encryption circuit 54.

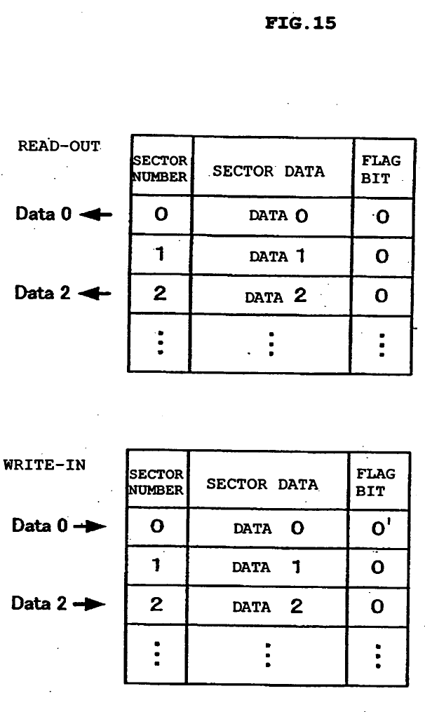

FIG. 15 is a view showing aspects of the sector data 1402 and the flag bits 1403 when data reading and writing is executed in the state of turning off the encryption function of the hard disk device 100.

When data reading and writing is executed in the state where the encryption function of the hard disk device 100 is kept turned off, the sector data 1402 are unencrypted raw data and the value of the flag bit 1403 is kept to “0”.

In the example shown in FIG. 15, the sector data 1402 corresponding to the sector numbers “0” and “2” are read out and written again. However, those data are not encrypted and the values of the corresponding flag bits 1403 remain at “0”.

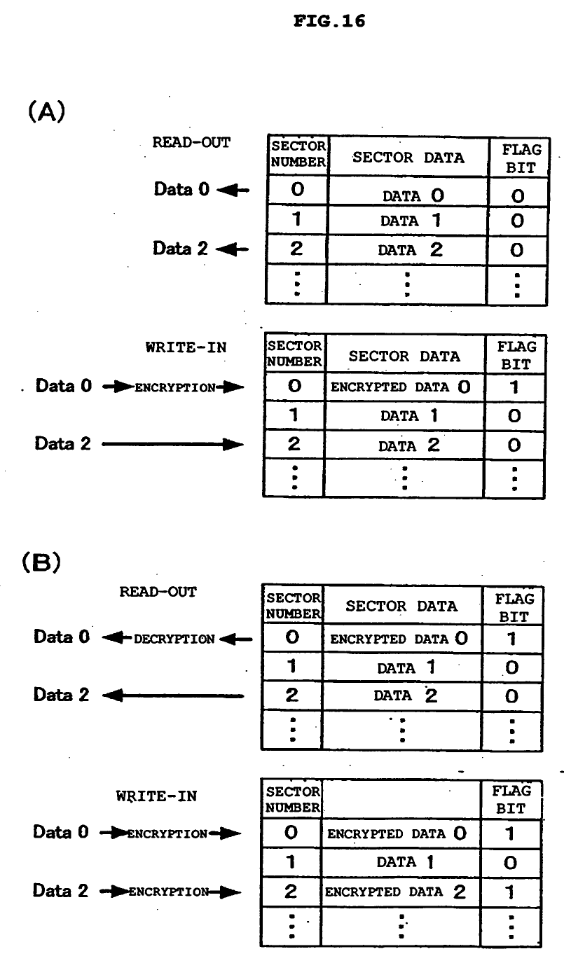

FIGS. 16A and 16B are views showing aspects of the sector data 1402 and the flag bits 1403 when data reading and writing is executed in the state of turning on the encryption function of the hard disk device 100.

When the encryption function of the hard disk device 100 is turned on, encryption will be executed in the data writing thereafter and the value of the flag bit 1403 will be set to “1”. In other words, after the encryption function is turned on, the stored data in the magnetic disk 10 will be stepwise encrypted every time the data writing processing takes place. For this reason, the user can access the data immediately after turning the encryption function on without waiting for the entire encryption of the stored data.

In reading the stored data, data are read out directly if the value of the flag bit 1403 is set to “0” (that is, in the case of reading the unencrypted data). On the contrary, if the value of the flag bit 1403 is set to “1” (that is, in the case of reading the encrypted data), the read-out data are decrypted.

In the example shown in FIG. 16A, the sector data 1402 corresponding to the sector numbers “0” and “2” are read out and new data are written in the sector number “0”. In this event of data writing, the sector data 1402 being written are encrypted and the value of the corresponding flag bit 1403 is set to “1”. Meanwhile, in the example shown in FIG. 16B, the sector data 1402 corresponding to the sector numbers “0” and “2” are read out and new data are written therein. The sector data 1402 in the sector number “0” are encrypted upon writing as shown in FIG. 16A. Accordingly, the sector data 1402 therein are decrypted upon reading. In addition, both of the sector data 1402 to be newly written in the sector numbers “0” and “2” are encrypted, whereby the values of the corresponding flag bits 1403 are set to “1”.

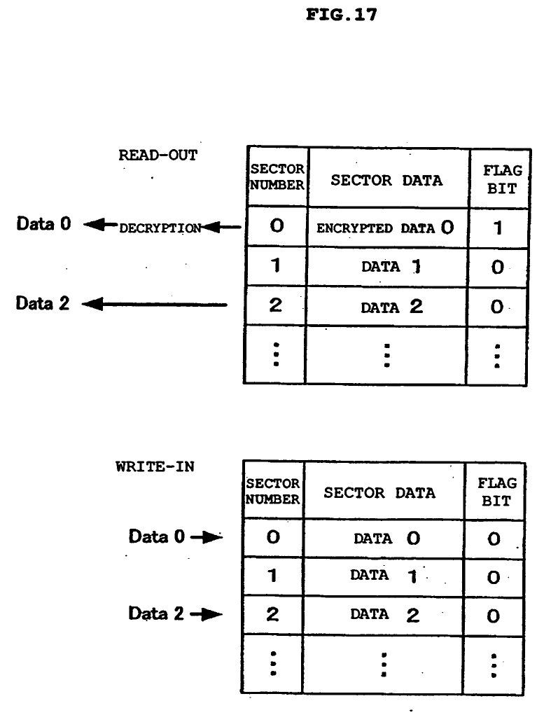

FIG. 17 is a view showing aspects of the sector data 1402 and the flag bits 1403 when data reading and writing is executed in the state where the encryption function of the hard disk device 100 is once turned on and then turned off again.

In this case, the sector data 1402 written in the state of turning on the encryption function are encrypted. Accordingly, the relevant sector data 1402 are decrypted upon reading. Meanwhile, the unencrypted sector data 1402 are read out directly. The sector data 1402 to be newly written after setting the encryption function to an off-state are not encrypted, whereby the values of the corresponding flag bits 1403 are set to “0”.

In the example shown in FIG. 17, the sector data 1402 corresponding to the sector numbers “0” and “2” are read out and new data are written therein. In this event, the encrypted sector data 1402 in the sector number “0” are decrypted upon reading. In the meantime, no encryption is executed upon writing.

In this way, the encryption and decryption processing is executed in response to the turning on and off of the encryption function of the hard disk device 100 every time of data writing and reading in and out of each sector. Here, as described in the chapter “A. Processing concerning management of an encryption key”, in the case of executing the user verification by use of the personal identification information such as a password, the verification is executed when the encryption function is set to an on-state so as to use the encryption key, and the encryption key is made usable without the verification when the encryption function is set to an off-state (by means of saving the unencrypted encryption key in the magnetic disk 10 as described in the operation 7, for example). In this way, when the encryption function is turned off, the sector data 1402 are automatically decrypted upon reading if the corresponding flag bit 1403 is set to “1”. Accordingly, the user can read and write the data without recognizing as to whether the readout data has been encrypted or not.

Here, when the single hard disk device 100 is shared by a plurality of users, the management of the encryption processing for each sector by user can be executed if it is possible to prepare a plurality of flag bits 1403 for each sector.

In the above-described control for encryption and decryption of the stored data, the CBC mode is applied as the use mode for encryption. Moreover, the sector number is used as the initial vector and the pseudo-random number C_{IV} obtained by encrypting the initial vector is initially applied upon encrypting the stored data. However, confidentiality is not required in the initial vector or the pseudorandom number C_{IV} obtained by encrypting the initial vector, and arbitrary values can be used therein. Moreover, the sector number is a value uniquely allotted to each sector. Accordingly, it is possible to obtain the ciphertext block, which are different from one another depending on the sectors, even if the sector numbers are directly used for encrypting the same data without conversion into random numbers. Therefore, it is also possible to execute the initial encryption by means of subjecting the sector number directly to the XOR operation with the plaintext block P_{0.}

As described above, in this embodiment, the encryption circuit 54 is incorporated into the hard disk controller 50 of the hard disk device 100. Accordingly, it is possible to execute the encryption processing of the stored data in the hard disk device 100 without executing special processing on the side of the computer device (the OS) being the host system, in other words, without recognition by the user.

Moreover, the data encryption key for use in the encryption processing of the stored data is encrypted with another encryption key created out of the personal identification information, and the encrypted data encryption key is stored in the magnetic disk 10. Accordingly, it is possible to deal with a change in the personal identification information just by re-encrypting the data encryption key. In this way, it is unnecessary to perform a complicated operation of decrypting the entire stored data and then re-encrypting the stored data again.

Furthermore, execution of the data encryption processing by each unit for reading and writing the stored data, such as the sector, is controlled in response to the turning on and off of the encryption function of the hard disk device 100. Accordingly, encryption or decryption of the stored data can be performed without allowing the user to recognize such an operation upon data access. For this reason, it is possible to mix the encrypted stored data and the unencrypted stored data together in the magnetic disk 10 comfortably. Therefore, it is unnecessary to perform a complicated operation of encrypting or decrypting the entire stored data every time when the encryption function is turned on or off. In addition, when certain software is preinstalled in the hard disk device 100 (or in the computer device) upon shipment, it is possible to realize the following using method easily, in which the software is kept unencrypted in the initial state of shipment because the software does not require confidentiality, and then the data written or read out after the encryption is turned on by the user are encrypted because the data is deemed to require confidentiality. Meanwhile, when it is necessary to encrypt the entire data stored in the magnetic disk 10 after turning on the encryption function, the entire data or the enter sectors may be serially read out and encrypted and rewritten after the encryption. In this way, although the processing requires some time, it is still possible to encrypt the entire data.

Note that the foregoing embodiment has been described while targeting on the hard disk device 100 including the magnetic disk as the recording medium. However, the present invention is also applicable to encryption processing for data writing and reading in and out of various external storage devices which adopts various recording media, including, optical discs such as a digital versatile disc (DVD) or a compact disc, memory cards, and the like.

Moreover, the foregoing embodiment has been described regarding the case of using the symmetric key cipher as the encryption method while considering the convenience for encrypting the write data and decrypting the read data. However, the encryption method for encrypting the stored data and the personal identification information is not necessarily limited to the common key encryption. For example, it is also possible to use public key cipher upon encrypting the personal identification information or the like, which does not need to be decrypted from the verification data into the original data in the event of executing the user verification.

Furthermore, the encryption processing according to the above-described embodiment is particularly suitable for the case where the encryption processing of the stored data is controlled not by the host system but by the external storage device itself and where the encryption processing and the user verification are executed at the same time. However, it is obvious that there is another possibility of an embodiment, in which the encryption processing and the user verification are executed under control of the host system. In this case, the encryption processing and the user verification will be executed by use of a program-controlled CPU of a computer device being the host system, or by use of the CPU and a given encryption circuit as the encryption processing means.

As described above, according to the present invention, it is possible to achieve the encryption processing of the stored data and management of the encryption key, which are suitable for the case when the user verification and encryption of the stored data are applied to a storage device at the same time.

Moreover, according to the present invention, it is possible to provide the method of encryption processing for the stored data suitable for the detachably implemented storage device, and to provide the storage device which can achieve the method of encryption processing.

Although advantageous embodiments of the present invention have been described in detail, it should be understood that various changes, substitutions, and alternations can be made therein without departing from spirit and scope of the inventions as defined by the appended claims.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed, is:

1. A data storage device for an information processing device, the data storage device comprising:
an encryption circuit for encrypting desired data and personal identification information by use of an encryption key created out of a given piece of the personal identification information;
a recording medium for recording the data and the personal identification information encrypted by the encryption circuit; and
a control unit for executing user verification by use of the encrypted personal identification information stored in the recording medium.

2. The data storage device according to claim 1,
wherein the encryption circuit encrypts the encryption key by use of a different encryption key, and
the recording medium records the encryption key encrypted by use of the different encryption key.

3. The data storage device according to claim 1,
wherein the recording medium includes a special storage area which is inaccessible in normal use, and
the recording medium records the encryption key in the special storage area.

4. The data storage device according to claim 1,
wherein the encryption circuit creates a plurality of encryption keys out of a plurality of personal identification information and controls the user identification and the data encryption depending on each of the plurality of encryption keys, and
the recording medium manages the storage areas in accordance with the plurality of keys, and records the encrypted data in the respective storage areas by use of the corresponding encryption keys.

5. A data storage device for an information processing device, the data storage device comprising:
an encryption circuit for encrypting desired data by use of a first encryption key and for encrypting the first encryption key and personal identification information by use of a second encryption key created out of a given piece of the personal identification information;
a recording medium for recording the data encrypted by use of the first encryption key, the first encryption key encrypted by use of the second encryption key, and the personal identification information encrypted by use of the second key; and
a control unit for executing user verification by use of the encrypted personal identification information stored in the recording medium.

6. The data storage device according to claim 5,
wherein the encryption circuit decrypts the encrypted first encryption key being read out of the recording medium by use of the second encryption key, and executes any of encryption and decryption of the desired data by use of the decrypted first encryption key.

7. A hard disk device comprising:
a magnetic disk being a recording medium;
a read-and-write mechanism for writing and reading data in and out of the magnetic disk; and
a control mechanism having an encryption function for encrypting data to be written in the magnetic disk and for decrypting the encrypted data to be read out of the magnetic disk, the control mechanism for controlling reading and writing the data by the reading-and-writing mechanism,
wherein the control mechanism executes encryption of the data to be written in the magnetic disk for each unit of writing and reading data in and out of a storage area of the magnetic disk upon processing of writing the data in the magnetic disk, in response to turning on and off of the encryption mechanism.

8. The hard disk device according to claim 7,
wherein the control mechanism judges as to whether the data are encrypted or not upon reading the data out of the storage medium, and further decrypts the data when the data are encrypted.

9. The hard disk device according to claim 7,
wherein the control mechanism decrypts the read-out data when the data read out of the recording medium are encrypted, and
the control mechanism encrypts and writes the data in the recording medium when the encryption function is turned on.

10. The hard disk device according to claim 7,
wherein the control mechanism includes an encryption function for encrypting desired data and personal identification information by use of an encryption key created out of a given piece of the personal identification information, and
the control mechanism executes user verification by use of the encrypted personal identification information.

11. The hard disk device according to claim 10,
wherein the encryption function of the control mechanism creates a plurality of encryption keys out of a plurality of personal identification information and controls the user identification and the data encryption depending on each of the plurality of encryption keys, and
the magnetic disk manages storage areas in accordance with the plurality of keys, and records the encrypted data in the respective storage areas by use of the corresponding encryption keys.

12. The hard disk device according to claim 7,
wherein the control mechanism includes an encryption function for encrypting desired data by use of a first encryption key and for encrypting the first encryption key and personal identification information by use of a second encryption key created out of a given piece of the personal identification information, and
the control mechanism executes user verification by use of the encrypted personal identification information.

13. An information processing device comprising:
an operation control unit for executing various operation processing; and
a data storage device for storing data to be processed by the operation control unit,
wherein the data storage device includes an encryption function for encrypting desired data by use of a data encryption key and for encrypting personal identification information by use of an verification encryption key created out of a given piece of the personal identification information, and
the data storage device executes user verification by use of the encrypted personal identification information.

14. The information processing device according to claim 13, wherein the data encryption key and the verification encryption are mutually identical.

15. The information processing device according to claim 13, wherein the data storage device encrypts the data encryption key by use of a different encryption key and saves the encrypted data encryption key.

16. The information processing device according to claim 15,
wherein the data storage device encrypts the data encryption key by use of the verification encryption key as the different encryption key.

17. A data processing method for a data storage device for executing data writing and reading in and out of a recording medium of a data storage device, the data processing method for a data storage device comprising the steps of:
creating an encryption key out of a given piece of personal identification information;
encrypting the personal identification information by use of the encryption key and thereby recording the encrypted personal identification information in the recording medium as verification data;
executing user verification based on the verification data recorded in the recording medium; and
executing any of encrypting write data transmitted from a host system by use of the encryption key and thereby recording the encrypted write data in the recording medium, and, decrypting the data read out of the recording medium by use of the encryption key and thereby transmitting the decrypted data to the host system.

18. The data processing method for a data storage device according to claim 17, further comprising the steps of:
encrypting the encryption key by use of a different encryption key and thereby recording the encrypted encryption key in the recording medium; and
decrypting the encrypted encryption key by use of the different encryption key and thereby decrypting the data read out of the recording medium by use of the decrypted encryption key.

19. A data processing method for a data storage device for executing data writing and reading in and out of a recording medium of a data storage device, the data processing method for a data storage device comprising the steps of:
creating a verification encryption key out of a given piece of personal identification information;
encrypting the personal identification information by use of the verification encryption key and recording the encrypted personal identification information in the recording medium as verification data, and further encrypting a data encryption key by use of the verification encryption key and thereby recording the encrypted data encryption key in the recording medium;
executing user verification based on the verification data recorded in the recording medium;
decrypting the data encryption key recorded in the recording medium by use of the verification encryption key; and
executing any of encrypting write data transmitted from a host system by use of the decrypted data encryption key and thereby recording the encrypted write data in the recording medium, and decrypting the data read out of the recording medium by use of the data encryption key and thereby transmitting the decrypted data to the host system.

20. The data processing method for a data storage device according to claim 19, further comprising the step of:
decrypting the encrypted data encryption key recorded in the recording medium along with a change in the personal identification information by use of the verification encryption key created out of the personal identification information prior to the change, and then encrypting the data encryption key again by use of the verification encryption key created out of the personal identification information after the change and thereby storing the data encryption key in the recording medium.

21. The data processing method for a data storage device according to claim 19, further comprising the step of:
decrypting the encrypted data encryption key recorded in the recording medium upon disabling encryption of the data recorded in the recording medium by use of the verification encryption key created out of the personal identification information prior to a change and thereby storing the decrypted data encryption key in the recording medium.

22. A program for controlling a computer to control data writing and reading in and out of a magnetic disk, the program causing the computer to execute the processes of:
creating an encryption key out of a given piece of personal identification information;
encrypting the personal identification information by use of the encryption key and thereby recording the encrypted personal identification information in the magnetic disk as verification data;
executing user verification based on the verification data recorded in the magnetic disk; and
executing any of encrypting write data transmitted from a host system by use of the encryption key and thereby recording the encrypted write data in the magnetic disk, and decrypting the data read out of the magnetic disk by use of the encryption key and thereby transmitting the decrypted data to the host system.

23. A program for controlling a computer to control data writing and reading in and out of a magnetic disk, the program causing the computer to execute the processes of:
creating an verification encryption key out of a given piece of personal identification information;
encrypting the personal identification information by use of the verification encryption key and recording the encrypted personal identification information in the magnetic disk as verification data, and further encrypting a data encryption key by use of the verification encryption key and thereby recording the encrypted data encryption key in the magnetic disk;
executing user verification based on the verification data recorded in the magnetic disk;
decrypting the data encryption key recorded in the magnetic disk by use of the verification encryption key; and
executing any of encrypting write data transmitted from a host system by use of the decrypted data encryption key and thereby recording the encrypted write data in the magnetic disk, and decrypting the data read out of the magnetic disk by use of the data encryption key and thereby transmitting the decrypted data to the host system.
